(19) United States
(12) Patent Application Publication
(10) Pub. No.: US 2014/0279046 A1
(43) Pub. Date: Sep. 18, 2014

(54) ADVERTISEMENT PROVIDING APPARATUS AND ADVERTISEMENT PROVIDING METHOD

(71) Applicant: YAHOO JAPAN CORPORATION, Tokyo (JP)

(72) Inventor: Tsutomu SANADA, Tokyo (JP)

(73) Assignee: YAHOO JAPAN CORPORATION, Tokyo (JP)

(21) Appl. No.: 14/176,946

(22) Filed: Feb. 10, 2014

(30) Foreign Application Priority Data
Mar. 12, 2013 (JP) 2013-048821

(51) Int. Cl. G06Q 50/00; G06Q 30/02

(52) U.S. Cl. CPC G06Q 50/01; G06Q 30/0269
USPC 705/14.66

(57) ABSTRACT

An advertisement providing apparatus includes a first advertisement providing unit, a friend list acquisition unit, a score calculation unit, and a second advertisement providing unit. The first advertisement providing unit is configured to provide a first advertisement to a user group including one or a plurality of users. The friend list acquisition unit is configured to acquire a friend list of a user who clicked on the first advertisement among the users included in the user group. The score calculation unit is configured to calculate, for each friend user included in the friend list, a score in which a click tendency of the friend user is reflected. The second advertisement providing unit is configured to provide a second advertisement that is the same as the first advertisement, to a friend user having a score that satisfies a certain condition.

### CROSS-REFERENCE TO RELATED APPLICATIONS

The present invention contains subject matter related to Japanese Patent Application No. 2013-048821 filed in the Japan Patent Office on Mar. 12, 2013, the entire contents of which are incorporated herein by reference.

### BACKGROUND OF THE INVENTION

1. Field of the Invention

The present invention relates to a technique of providing advertisements via a network such as the Internet.

2. Description of the Related Art

There is targeted advertising through which advertisements are provided to users who satisfy a certain condition.

For efficient targeted advertising, two conditions that
content of an advertisement matches, for example, the curiosity, interest, or attribute of users, and
an advertisement is provided to users who are likely to respond to it are important.

For example, the former condition is used in the following ways:
Example 1) An advertisement for automobiles is provided to users interested in automobiles;
Example 2) A female-targeted advertisement, such as one for jewelry, is provided to female users; and
Example 3) An advertisement for apartments located in Tokyo is provided to users who live in Tokyo.

As for the latter condition, it is desirable to target users having a high tendency to click on advertisements (hereinafter, referred to as clickers). This is related to facts that
unoccupied people are likely to click on advertisements,
busy people do not click on advertisements even if they see advertisements which they are interested in, and
advertising has no effect in offices where clicking of advertisements is prohibited.

In order to provide targeted advertising that matches the curiosity, interest, or attribute of users, it is generally essential to identify a category of an advertisement, to identify categories which users are curious about or interested in from their behaviors, and to acquire attribute information of the users in advance. Specifically, work for
identifying a category of an advertisement (e.g., automobile, real estate, or travel),
identifying a category of each search keyword used by each user,
identifying a category of content of each website viewed by each user,
identifying attribution information of each user, such as gender and age, and
so forth
   is generally needed.

In order to identify a category, a category classification method and a category hierarchical structure are to be decided upon in advance. There are various classification methods and various category hierarchical structures, and examples thereof include
1) an automobile classification method based on a criterion of domestic automobiles or foreign automobiles; large-sized, middle-sized, or small-sized automobiles; luxury automobiles or general automobiles; or the like, and
2) a user attribute classification method based on the age, occupation, or the like.

After the category classification method and the category hierarchical structure are decided upon, categorization work (i.e., work for determining which category an advertisement, keyword, website, or the like belong to) is performed. Manual categorization work is highly accurate but takes time, and thus is not suitable for large-scale categorization.

In contrast, automatic categorization by software can handle large-scale categorization but is less accurate than manual categorization.

The inventor has proposed a method for distributing an advertisement to users who are highly likely to click on advertisements, regardless of categories which the users are curious about or interested in (hereinafter, this method is occasionally referred to as clicker-targeted advertising) (see Japanese Unexamined Patent Application Publication No. 2012-141785 (Japanese Patent No. 5094956)). This method requires neither detailed identification of the curiosity or interest of the users nor categorization work.

However, because this method does not take the aforementioned first condition into consideration, contents of advertisements sometimes do not match the curiosity or interest of users or their environments. Consequently, the most desirable users for advertisers are likely to be overlooked.

### SUMMARY OF THE INVENTION

An embodiment of the present invention has been proposed in view of the drawback of the related art and enables efficient targeted advertising that matches the curiosity or interest of users, while keeping a benefit of clicker-targeted advertising of not requiring any categorizing work.

To this end, according to an embodiment of the present invention, there is provided an advertisement providing apparatus including a first advertisement providing unit, a friend list acquisition unit, a score calculation unit, and a second advertisement providing unit. The first advertisement providing unit is configured to provide a first advertisement to a user group including one or a plurality of users. The friend list acquisition unit is configured to acquire a friend list of a user who clicked on the first advertisement among the users included in the user group, the friend list including one or a plurality of friend users. The score calculation unit is configured to calculate, for each of the friend users included in the friend list, a score in which a click tendency of the friend user is reflected. The second advertisement providing unit is configured to provide a second advertisement that is the same as the first advertisement, to a friend user having a score that satisfies a certain condition among the friend users.

The embodiment of the present invention uses a social graph of each user and a method for predicting a click tendency of the user in combination, thereby enabling efficient targeted advertising that matches the curiosity or interest of users, while keeping a benefit of clicker-targeted advertising of not requiring any categorizing work.

### BRIEF DESCRIPTION OF THE DRAWINGS

FIG. 1 is a diagram illustrating an example of a configuration of a system according to an embodiment of the present invention.

FIG. 2 is a diagram illustrating an example of a data structure of a user database (hereinafter, abbreviated as DB).

FIG. 3 is a diagram illustrating an example of a data structure of a log DB.

FIG. 4 is a diagram illustrating an example of a data structure of a social graph DB.

FIG. 5 is a diagram illustrating an example of a data structure of click tendency information.

FIG. 6 is a diagram illustrating an example of a data structure of target user information.

FIG. 7 is a sequence diagram illustrating an example of a process according to the embodiment.

### DETAILED DESCRIPTION OF THE PREFERRED EMBODIMENTS

The following describes a preferred embodiment of the present invention.

### Configuration

FIG. 1 is a diagram illustrating an example of a configuration of a system according to an embodiment of the present invention.

Referring to FIG. 1, a plurality of terminal apparatuses 2 operated by users are connected to a network 1 such as the Internet. Examples of the terminal apparatuses 2 include smartphones, mobile phones, and personal computers (PCs). The terminal apparatuses 2 each include a browser (or a web browser) 21 generally used. The browser 21 has functions such as of requesting, acquiring, and displaying page data written in a language such as Hypertext Markup Language (HTML) and of transmitting form data in accordance with a protocol such as Hypertext Transfer Protocol (HTTP) which is the standard protocol of the Internet.

A social networking site (SNS site) 3 that provides a social networking service (SNS), a website 4 that provides general information, and an advertisement providing apparatus 5 that provides advertisements are also connected to the network 1.

The advertisement providing apparatus 5 includes functional units such as a click tendency calculation unit 51, a first-time advertisement-providing-target user determination unit (hereinafter, simply referred to as an initial target user determination unit) 52, a friend list acquisition unit 53, a score calculation unit 54, a subsequent-time advertisement-providing-target user determination unit (hereinafter, simply referred to as a subsequent target user determination unit) 55, and an advertisement providing unit 56. A combination of the initial target user determination unit 52 and the advertisement providing unit 56 corresponds to a first advertisement providing unit configured to provide a first advertisement to a user group including one or a plurality of users. The friend list acquisition unit 53 corresponds to a friend list acquisition unit configured to acquire a friend list of a user who clicked on the first advertisement among the users included in the user group, the friend list including one or a plurality of friend users. The score calculation unit 54 corresponds to a score calculation unit configured to calculate, for each of the friend users included in the friend list, a score in which a click tendency of the friend user is reflected. A combination of the subsequent target user determination unit 55 and the advertisement providing unit 56 corresponds to a second advertisement providing unit configured to provide a second advertisement that is the same as the first advertisement, to a friend user having a score that satisfies a certain condition among the friend users.

These functional units are implemented by a computer program executed on hardware resources, such as a central processing unit (CPU), a read only memory (ROM), and a random access memory (RAM), of a computer constituting the advertisement providing apparatus 5. These functional units are not necessarily allocated in a single computer and may be allocated in a distributed manner.

The advertisement providing apparatus 5 uses and includes DBs such as a user DB 501, a log DB 502, a social graph DB 503, a click tendency information memory unit 504, and an advertisement-providing-target user information memory unit (hereinafter, simply referred to as a target user information memory unit) 505. These DBs or the like systematically hold predetermined data on a storage medium, such as a hard disk drive (HDD), included in the computer constituting the advertisement providing apparatus 5. Note that the user DB 501, the log DB 502, the social graph DB 503, the click tendency information memory unit 504, and the target user information memory unit 505 are not necessarily allocated in the advertisement providing apparatus 5 and may be allocated in another apparatus.

FIG. 2 is a diagram illustrating an example of a data structure of the user DB 501. The user DB 501 includes fields of a “user ID” and an “attribute”, for example. The “user ID” field contains information identifying a user. Examples of the “user ID” include a member ID with which a user is specifically identified and a browser cookie with which access from the same browser is identified (by writing the browser cookie as cookie information of the browser at the initial access and by referring to the written cookie information at the subsequent accesses). The “attribute” field contains various pieces of information, such as the name, address, gender, age, and preference of a user.

FIG. 3 is a diagram illustrating an example of a data structure of the log DB 502. The log DB 502 includes fields of a “date and time”, a “user ID”, and a “behavior content”, for example. The “date and time” field contains information of the occurrence date and time of a logged event. The “user ID” field contains information identifying a user. The “behavior content” field contains, for example, an advertisement ID of an advertisement viewed by a user, a via-user ID, and clicked-or-not-clicked information. The advertisement ID is information identifying an advertisement. The via-user ID is, in the case where the advertisement is provided to a user in response to a behavior of a user X who is a friend of the user, information identifying the user X. The clicked-or-not-clicked information is information indicating whether or not the user clicked on the advertisement.

FIG. 4 is a diagram illustrating an example of a data structure of the social graph DB 503. The social graph DB 503 includes fields of a “user ID” and a “friend user ID”, for example. The “user ID” field contains information identifying a user. The “friend user ID” field contains information identifying one or more friends of the user. Examples of friends include family members, people who attended the same school, people who work at the same office (e.g., colleagues, bosses, and subordinates), people who are related in terms of business (e.g., salespersons and clients), people of the same generation, people having the same hobby, people whom the user hangs out with, people whom the user go shopping with, and people whom the user frequently exchanges emails with. In a social graph, users who are friends are linked to one another, and users having close curiosity, interests, and attributes are likely to be friends.

FIG. 5 is a diagram illustrating an example of a data structure of click tendency information stored in the click tendency information memory unit 504. The click tendency information includes fields of a “user ID”, a “user's own click tendency”, and a “via-user click tendency”, for example. The “user ID” field contains information identifying a user. The “user's own click tendency” field contains a value representing how likely the user is to click on advertisements. This “user's own click tendency” may be obtained by calculating a click through rate (CTR), which is a ratio of the number of clicked advertisements to the number of provided advertisements, from the user's access log for a certain past period.

The “via-user click tendency” field contains a value representing how likely the user is to click on advertisements when the user is provided with the advertisements as a friend of another user (or when advertisements are propagated). The via-user click tendency is calculated for each of other users (i.e., source users). In the case where there is log data of advertisements propagated via an SNS, this “via-user click tendency” may be obtained by aggregating log data for each user of interest and calculating a CTR representing a ratio of the number of clicked advertisements to the number of advertisements provided via a source user.

In the case there is no log data of advertisements propagated via an SNS, the “via-user click tendency” may be obtained in the following manner. Let a user A denote the user of interest and a user X denote the source user. Also, let
N1 denote the number of times the user X and the user A clicked on the same advertisement, and
N2 denote the number of times the user X clicked on but the user A did not clicked on the same advertisement. Then, the user A's click tendency when the user X serves as the source may be obtained through calculation of N1/(N1+N2).

FIG. 6 is a diagram illustrating a data structure of advertisement-providing-target user information (hereinafter, simply referred to as target user information) stored in the target user information memory unit 505. The target user information includes fields of an “advertisement ID” and a “user ID”, for example. The “advertisement ID” field contains information identifying an advertisement. The “user ID” field contains information identifying a user.

Referring back to FIG. 1, the click tendency calculation unit 51 of the advertisement providing apparatus 5 has a function of calculating, for each user, the “user's own click tendency” and the “via-user click tendency” based on the log data stored in the log DB 502 and the social graph data stored in the social graph DB 503; and of storing the obtained results in the click tendency information memory unit 504.

The initial target user determination unit 52 has a function of determining users (or a user group) serving as the start of propagation of a certain advertisement; and of storing user IDs of the determined users in the target user information memory unit 505 in association with an advertisement ID of the certain advertisement. This user group may be a group of users whose “user's own click tendency” stored in the click tendency information memory unit 504 exceeds a predetermined value or a group of users randomly selected from the user DB 501.

The friend list acquisition unit 53 has a function of identifying, using the log data stored in the log DB 502, users who clicked on a provided advertisement from among the initial target users; and of acquiring, for each of the identified users, a friend list from the social graph data stored in the social graph DB 503. Here, users who clicked on the advertisement are targeted because the advertisement should match the curiosity, interest, or attribute of the users who clicked on it and it is highly probable that the advertisement will match the curiosity, interest, or attribute of friends of the users. As a result, the friends are highly likely to click on the advertisement, and continuous propagation of the advertisement among the users having the matching curiosity, interest, or attribute is expected.

The score calculation unit 54 has a function of calculating, for each of users included in the friend list acquired by the friend list acquisition unit 53, a score in which the click tendency of the user is reflected.

### Examples of the score calculation method are as follows

a) calculating, for each of the users A included in the friend list, a score by multiplying a click tendency value (i.e., the user's own click tendency) of the user A by the number of friends of the user A in the social graph;
b) calculating, for each of the users A included in the friend list, a score by adding click tendency values (i.e., the user's own click tendencies) of all the friends of the user A in the social graph to the click tendency value (i.e., the user's own click tendency) of the user A;
c) calculating an overall score from the scores determined by the methods a) and b);
d) calculating, for each of the users A included in the friend list, a score by multiplying a click tendency value (i.e., the via-user click tendency) of the user A for advertisements provided via the user X serving as the source of the acquired friend list by the number of friends of the user A in the social graph;
e) calculating, for each of the users A included in the friend list, a score by multiplying the click tendency value (i.e., the via-user click tendency) of the user A for advertisements provided via the user X serving as the source of the acquired friend list by the number of friends of the user A in the social graph having the click tendency values (i.e., the via-user click tendencies) for advertisements provided via the user A larger than or equal to a predetermined value;
f) calculating, for each of the users A included in the friend list, a score by adding the click tendency values (i.e., the user's own click tendencies) of all the friends of the user A in the social graph to the click tendency value (i.e., the via-user click tendency) of the user A for advertisements provided via the user X serving as the source of the acquired friend list;
g) calculating, for each of the users A included in the friend list, a score by adding the click tendency values (i.e., the via-user click tendencies) of all the friends of the user A in the social graph for advertisements provided via the user A to the click tendency value (i.e., the via-user click tendency) of the user A for advertisements provided via the user X serving as the source of the acquired friend list; and
h) calculating an overall score from a plurality of values from among the scores determined by the methods d) to g).

In the above-described methods a), d), and e), the click tendency value is multiplied by the “number of friends”. This is because a possibility of the advertisement propagating to a wide range of users increases as the number of friends of the user A increases.

Even for the same user, the click tendency changes depending on via who advertisements have been propagated. For example, suppose that the user A is likely to click on (i.e., has a high click tendency for) advertisements having propagated via a friend X. In this case, the curiosity or interest of the user A and the friend X is close. Suppose that the user A is less likely to click on (i.e., has a low click tendency for) advertisements having propagated via a friend Y. In this case, the curiosity or interest of the user A and the friend Y is not close.

The above-described methods a) to c) use, for each user included in the friend list, the user's own click tendency which does not take into account via who advertisements have been propagated. Thus, when a user has a high click tendency for advertisements having propagated via a specific user but has a low average click tendency, the user is possibly excluded from the advertisement-providing target.

In contrast, the above-described methods d) to h) use the via-user click tendency which is a click tendency determined for each user via who advertisements have been provided. Thus, all the users potentially having a high click tendency can be added to the advertisement-providing target.

The subsequent target user determination unit 55 has a function of determining users each having the score calculated by the score calculation unit 54 that satisfies a predetermined condition, as users (or a user group) to be provided with an advertisement that is the same as the initial advertisement; and of storing user IDs of the determined users in the target user information memory unit 505 in association with an advertisement ID of the advertisement. For example, the predetermined condition may be that the score exceeds or is below a predetermined value or in a predetermined range depending on the definition of the score. A configuration may be made to avoid duplicated addition when the target user information memory unit 505 already contains data associating the same advertisement and users with each other.

The advertisement providing unit 56 has a following function. In response to an advertisement request (i.e., a request for acquiring an advertisement to be put on a site requested by a user) from the website 4 or when an advertisement article is posted on the SNS site 3 or an advertisement is provided to a user by email or the like, the advertisement providing unit 56 acquires and provides an advertisement ID associated with the user ID serving as the target user ID, based on the data stored in the target user information memory unit 505. After the advertisement is provided, data associating the advertisement and the user with each other may be deleted from the target user information memory unit 505 or may be attached with an invalid flag so as not to be used again. When the same advertisement is repeatedly provided to the same user, deletion or invalidation of the data associating the advertisement and the user with each other may be omitted, or the data may be deleted or invalidated when the advertisement is provided to the user a predetermined number of times.

The friend list acquisition unit 53 may perform the similar process for each user who clicked on the provided advertisement among the users determined by the subsequent target user determination unit 55. Based on the acquired friend list, the score calculation unit 54 and the subsequent target user determination unit 55 may perform the similar processes. These processes are repeatedly performed until the advertisement is no longer clicked on by any user.

Illustration of functional units configured to manage the user DB 501, the log DB 502, and the social graph DB 503 is omitted. However, when data managed by each of these DBs is changed, the data is updated at a certain timing.

### Operation

FIG. 7 is a sequence diagram illustrating an example of a process performed in the embodiment described above.

Referring to FIG. 7, the click tendency calculation unit 51 of the advertisement providing apparatus 5 calculates, for each user, the user's own click tendency and the via-user click tendency at a predetermined timing, based on the log data stored in the log DB 502 and the social graph data stored in the social graph DB 503. The click tendency calculation unit 51 then stores the determined click tendencies in the click tendency information memory unit 504 (step S101).

Then, the initial target user determination unit 52 of the advertisement providing apparatus 5 determines users (or a user group) serving as the start of propagation of a certain advertisement. The initial target user determination unit 52 stores user IDs of the determined users in the target user information memory unit 505 in association with an advertisement ID of the advertisement (step S102).

Thereafter, a page request is transmitted to the website 4 from the terminal apparatus 2 (step S103). The website 4 transmits an advertisement request together with the user ID to the advertisement providing apparatus 5 (step S104). Then, the advertisement providing unit 56 of the advertisement providing apparatus 5 acquires an advertisement ID associated with the user ID serving as the target user ID, based on the data stored in the target user information memory unit 505 (step S105). The advertisement providing unit 56 then returns advertisement information (e.g., link information to advertisement content, or content data) to the website 4 (step S106). The website 4 then returns page information containing the acquired advertisement information to the terminal apparatus 2 (step S107). The terminal apparatus 2 displays the page information. As a result, the advertisement is displayed.

At a certain timing (including a spontaneous timing and a timing at which a request is received from the SNS site 3), the advertisement providing unit 56 of the advertisement providing apparatus 5 acquires an advertisement ID associated with the user ID serving as the target user ID, based on the data stored in the target user information memory unit 505 (step S108). The advertisement providing unit 56 then transmits an advertisement article posting request to the SNS site 3 (step S109). When the user accesses the SNS site 3 from the terminal apparatus 2, the advertisement article is displayed as an advertisement associated with the user. Alternatively, the advertisement providing unit 56 may transmit an email containing the advertisement to the user.

Thereafter, the friend list acquisition unit 53 of the advertisement providing apparatus 5 identifies users who clicked on the advertisement from among the initial target users, by using the log data stored in the log DB 502. The friend list acquisition unit 53 then acquires, for each of the identified users, the friend list of the user based on the social graph data stored in the social graph DB 503 (step S110).

Subsequently, the score calculation unit 54 of the advertisement providing apparatus 5 calculates, for each of the users included in the friend list acquired by the friend list acquisition unit 53, a score in which the click tendency of the user is reflected (step S111).

Then, the subsequent target user determination unit 55 of the advertisement providing apparatus 5 determines users whose scores calculated by the score calculation unit 54 exceed a predetermined value, as users (or a user group) to be provided with the same advertisement as the initial advertisement. The subsequent target user determination unit 55 stores user IDs of the determined users in the target user information memory unit 505 in association with an advertisement ID of the advertisement (step S112).

Thereafter, the advertisement providing unit 56 of the advertisement providing apparatus 5 provides the advertisement to the user of the terminal apparatus 2 through a process similar to the above-described one (steps S103 to S109).

The friend list acquisition unit 53, the score calculation unit 54, and the subsequent target user determination unit 55 may repeatedly perform the process until the advertisement is no longer clicked on by any user.

### Summarization

As described above, the embodiment uses a social graph of each user and a method for predicting a click tendency of the user in combination, thereby enabling efficient targeted advertising that matches the curiosity or interest of users, while keeping a benefit of clicker-targeted advertising of not requiring any categorizing work. Specifically, the user's curiosity or interest is implicitly obtained based on how an advertisement has propagated on a social graph. This enables an advertisement to be provided more efficiently while keeping the features of the clicker-targeted advertising.

More specifically, among friends of a user who clicked on an initial advertisement among users provided with the initial advertisement, friend users who have high click-tendency-based scores are provided with the same advertisement. The similar process is repeatedly performed for each of the friend users. Because it is guaranteed that friends represented by the social graph have close curiosity, interest, or attribute, propagation of the advertisement is continued for a long period. As a result, a situation in which content of the advertisement does not match the curiosity or interest of users or their environments may be reduced significantly.

If propagation of the advertisement ends after a short period, it becomes apparent after a short period that selection of the initial target users is inappropriate or the advertisement is not accepted by general users. This can result in actions such as reselection of the initial target users and replacement of the advertisement.

The present invention has been described above using the preferable embodiment of the present invention. Although the present invention has been described using specific concrete examples, it is obvious that various modifications and alterations can be made in these concrete examples without departing from a broad gist and scope of the present invention defined by claims. That is, the present invention should not be construed as being limited by details of the concrete examples and the accompanying drawings.

What is claimed is:

1. An advertisement providing apparatus comprising:
a first advertisement providing unit configured to provide a first advertisement to a user group including one or a plurality of users;
a friend list acquisition unit configured to acquire a friend list of a user who clicked on the first advertisement among the users included in the user group, the friend list including one or a plurality of friend users;
a score calculation unit configured to calculate, for each of the friend users included in the friend list, a score in which a click tendency of the friend user is reflected; and
a second advertisement providing unit configured to provide a second advertisement that is the same as the first advertisement, to a friend user having a score that satisfies a certain condition among the friend users.

2. The advertisement providing apparatus according to claim 1, wherein
the friend list acquisition unit, the score calculation unit, and the second advertisement providing unit are configured to repeatedly perform a process sequence in which
the friend list acquisition unit acquires a friend list of the friend user who clicked on the second advertisement provided by the second advertisement providing unit,
the score calculation unit calculates, for each friend user included in the acquired friend list, a score in which a click tendency of the friend user is reflected, and
the second advertisement providing unit provides the second advertisement to a friend user having a score that satisfies the certain condition among the friend users.

3. The advertisement providing apparatus according to claim 1, wherein the first advertisement providing unit is configured to select one or a plurality of users each having a click tendency value exceeding a predetermined value and to provide the first advertisement to the selected users.

4. The advertisement providing apparatus according to claim 1, wherein the first advertisement providing unit is configured to provide the first advertisement to one or a plurality of users selected at random.

5. The advertisement providing apparatus according to claim 1, wherein the score calculation unit is configured to calculate, for each of the friend users included in the friend list, a score by multiplying a click tendency value of the friend user by the number of friends of the friend user in a social graph.

6. The advertisement providing apparatus according to claim 1, wherein the score calculation unit is configured to calculate, for each of the friend users included in the friend list, a score by adding click tendency values of friends of the friend user in a social graph to the click tendency value of the friend user.

7. The advertisement providing apparatus according to claim 1, wherein the score calculation unit is configured to calculate, for each of the friend users included in the friend list, a score from a value obtained by multiplying the click tendency value of the friend user by the number of friends of the friend user in a social graph and a value obtained by adding click tendency values of the friends of the friend user in the social graph to the click tendency value of the friend user.

8. The advertisement providing apparatus according to claim 1, wherein the score calculation unit is configured to calculate, for each of the friend users included in the friend list, a score by multiplying the click tendency value of the friend user for advertisements provided via the user serving as a source of the acquired friend list by the number of friends of the friend user in a social graph.

9. The advertisement providing apparatus according to claim 1, wherein the score calculation unit is configured to calculate, for each of the friend users included in the friend list, a score by multiplying the click tendency value of the friend user for advertisements provided via the user serving as a source of the acquired friend list, by the number of friends of the friend user in a social graph having click tendency values for advertisements provided via the friend user larger than or equal to a predetermined value.

10. The advertisement providing apparatus according to claim 1, wherein the score calculation unit is configured to calculate, for each of the friend users included in the friend list, a score by adding click tendency values of friends of the friend user in a social graph, to the click tendency value of the friend user for advertisements provided via the user serving as a source of the acquired friend list.

11. The advertisement providing apparatus according to claim 1, wherein the score calculation unit is configured to calculate, for each of the friend users included in the friend list, a score by adding click tendency values of friends of the friend user in a social graph for advertisements provided via the friend user, to the click tendency value of the friend user for advertisements provided via the user serving as a source of the acquired friend list.

12. The advertisement providing apparatus according to claim 1, wherein the score calculation unit is configured to calculate, for each of the friend users included in the friend list, a score from a plurality of values from among
a value obtained by multiplying a click tendency value of the friend user for advertisements provided via the user serving as a source of the acquired friend list by the number of friends of the friend user in a social graph,
a value obtained by multiplying the click tendency value of the friend user for advertisements provided via the user serving as the source of the acquired friend list by the number of friends of the friend user in the social graph having click tendency values for advertisements provided via the friend user larger than or equal to a predetermined value,
a value obtained by adding click tendency values of friends of the friend user in the social graph to the click tendency value of the friend user for advertisements provided via the user serving as the source of the acquired friend list, and
a value obtained by adding click tendency values of the friends of the friend user in the social graph for advertisements provided via the friend user to the click tendency value of the friend user for advertisements provided via the user serving as the source of the acquired friend list.

13. An advertisement providing method comprising:
providing a first advertisement to a user group including one or a plurality of users;
acquiring a friend list of a user who clicked on the first advertisement among the users included in the user group, the friend list including one or a plurality of friend users;
calculating, for each of the friend users included in the friend list, a score in which a click tendency of the friend user is reflected; and
providing a second advertisement that is the same as the first advertisement, to a friend user having a score that satisfies a certain condition from among the friend users.
